(19) United States
(12) Patent Application Publication
(10) Pub. No.: US 2014/0034850 A1
(43) Pub. Date: Feb. 6, 2014

(54) Lighting Assembly

(71) Applicants: Tao Song, Shenzhen (CN); Tao Ding, Shenzhen (CN)

(72) Inventors: Tao Song, Shenzhen (CN); Tao Ding, Shenzhen (CN)

(73) Assignee: SHENZHEN CHINA STAR OPTOELECTRONICS TECHNOLOGY CO., LTD., Shenzhen (CN)

(21) Appl. No.: 13/583,219

(22) PCT Filed: Aug. 6, 2012
(86) PCT No.: PCT/CN2012/079706

§ 371 Date: Sep. 7, 2012

(30) Foreign Application Priority Data
Aug. 1, 2012 (CN) 201210271459.6

(51) Int. Cl. F21V 8/00

(52) U.S. Cl. 250/494.1; 362/606; 362/629; 362/623; 362/621

(57) ABSTRACT

A lighting assembly for liquid crystal alignment is disclosed. The lighting assembly includes a light guiding plate and a light source. The light guiding plate is made by quartz glass. The light guiding plate includes a light emitting surface, a light incident surface adjacent to the light emitting surface, and a bottom surface opposite to the light emitting surface. The light source faces toward the light incident surface of the light guiding plate. The light guiding plate contains a hydroxyl group in an amount less than or equal to 100 ppm. As the light source faces toward the light incident surface of the light guiding plate, the number of the light source may be reduced so that the light utilization rate is enhanced.

### BACKGROUND OF THE INVENTION

1. Field of the Invention

Embodiments of the present disclosure relate to lighting technology, and more particularly to lighting assembly for liquid crystal alignment.

2. Discussion of the Related Art

With the development of liquid crystal technology, electric fields controls arrangements of liquid crystal molecules so as to change transmission paths and phase of lights. Generally, liquid crystal alignment is adopted to control the arrangements and the directions of the liquid crystal molecules. The liquid crystal are exposed to ultra-violet rays to produce high polymer in the alignment process. The intensity and the uniform of the ultra-violet rays affects the alignment results of the liquid crystal molecules. As the liquid crystal panel is a planar, and thus light sources with uniform ultra-violet rays is needed.

FIG. 1 a schematic view of the structure of a conventional lighting assembly. The lighting assembly includes a reflective plate 110 and a plurality of ultra-violet sources 120. The ultra-violet sources 120 may be a point source, a line source, or a surface source emitting uniform ultra-violet rays toward a liquid crystal panel (not shown). The reflective plate 110 then reflects the ultra-violet rays to the liquid crystal panel.

However, it is obvious that more ultra-violet sources 120 are needed in the conventional lighting assembly. Thus, the design, assembly, system tuning, and replacement spare processes are more complex. In addition, the offset between the ultra-violet sources 120 and the liquid crystal panel are seriously affected by the light intensity and the uniform.

### SUMMARY

The object of the claimed invention is to provide a backlight module laving a light guiding plate reliably positioned therein, and liquid crystal devices with the backlight module.

In one aspect, a lighting assembly for liquid crystal alignment includes a light guiding plate, a light source, a reflective plate, and a prism plate. The light guiding plate is made by quartz glass. The light guiding plate includes a light emitting surface, a light incident surface adjacent to the light emitting surface, and a bottom surface opposite to the light emitting surface. The bottom surface is printed with a dot pattern for reflecting and guiding lights. The light source faces toward the light incident surface of the light guiding plate. The reflective plate is adjacent to the bottom surface of the light guiding plate. The prism plate is made by quartz glass. The prism plate includes a first surface with a trench-shaped prism structure, and a second surface adjacent to the light emitting surface of the light guiding plate. The light guiding plate contains a hydroxyl group in an amount less than or equal to 100 ppm. The prism plate contains the hydroxyl group in the amount less than or equal to 50 ppm. In addition, the light source includes ultra-violet lamps.

The light guiding plate contains the hydroxyl group in the amount less than or equal to 50 ppm. The lighting assembly further includes a shadow mask surrounding the light source so that the lights are reflected into the light incident surface of the light guiding plate. The light source comprises at least two ultra-violet lamps. The dot pattern is made by metallic lead.

In another aspect, the lighting assembly for liquid crystal alignment includes a light guiding plate, and a light source. The light guiding plate is made by quartz glass. The light guiding plate includes a light emitting surface, a light incident surface adjacent to the light emitting surface, and a bottom surface opposite to the light emitting surface. The light source faces toward the light incident surface of the light guiding plate. The light guiding plate contains the hydroxyl group in an amount less than or equal to 100 ppm.

The lighting assembly further includes a reflective plate adjacent to the bottom surface of the light guiding plate. The lighting assembly further includes a prism plate having a first surface with a trench-shaped prism structure and a second surface adjacent to the light emitting surface of the light guiding plate. The prism plate is made by the quartz glass, and contains the hydroxyl group in the amount less than or equal to 50 ppm. The light guiding plate contains the hydroxyl group in the amount less than or equal to 50 ppm. The lighting assembly further includes a shadow mask surrounding the light source so that the lights are reflected into the light incident surface of the light guiding plate. The light source are ultra-violet lamps. In addition, the light source includes at least two ultra-violet lamps. The bottom surface of the light guiding plate is printed with a dot pattern for reflecting and guiding lights. The dot pattern is made by metallic lead.

### BRIEF DESCRIPTION OF THE DRAWINGS

FIG. 1 is a schematic view of the structure of a conventional lighting assembly.

FIG. 2 is a schematic view of the structure of the lighting assembly of one embodiment.

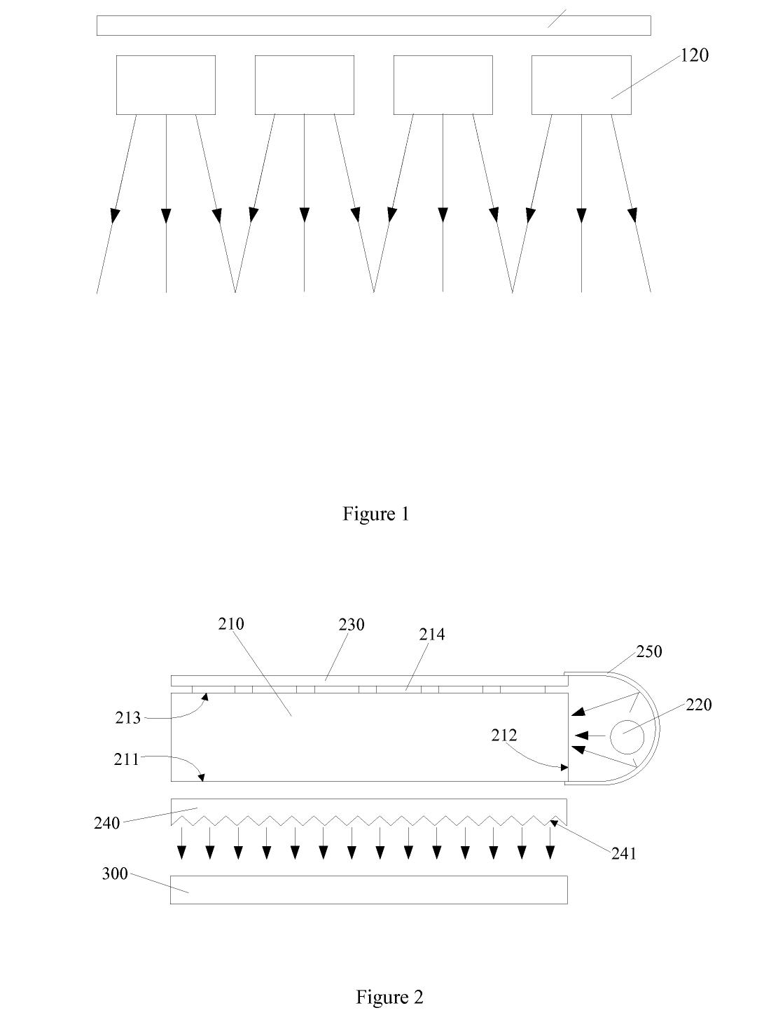

### DETAILED DESCRIPTION OF THE EMBODIMENTS

FIG. 2 is a schematic view of the structure of a lighting assembly of one embodiment, in which a liquid crystal panel 300 is shown for clearness. The lighting assembly is for lighting the liquid crystal panel 300 so as to achieve the liquid crystal alignment. The lighting assembly includes a light guiding plate 210, a light source 220, a reflective plate 230, a prism plate 240, and a shadow mask 250.

The light guiding plate 210 includes a light emitting surface 211, a light incident surface 212 adjacent to the light emitting surface 211, and a bottom surface 213 opposite to the light emitting surface 211. The light guiding plate 210 is made by quartz glass. The quartz glass has a high transmission rate for some kinds of lights, such as ultra-violate rays, and thus is different from normal glasses or transparent plastic materials with low transmission rate. The light guiding plate 210 contains a hydroxyl group in an amount less than or equal to 100 ppm. Preferably, the light guiding plate 210 contains the hydroxyl group in the amount less than or equal to 50 ppm so that the transmission rate with respect to the ultra-violate rays is larger than or equal to 90%. In addition, an effective time period of the light guiding plate 210 may be two thousand hours. After the effective time period, the transmission rate with respect to ultra violet lights is reduced to 80 percent of an initial value. Furthermore, the bottom surface 213 of the light guiding plate 210 is printed with a dot pattern 214 for reflecting and guiding the. lights. The dot pattern 214 is made by materials with high reflective rate and is not capable of absorbing the lights. In the embodiments, the dot pattern 214 is made by metallic lead.

In one embodiment, the light source 220 includes at least two ultra-violet lamps so that the four light incident surfaces 212 of the light guiding plate 210 are exposed to the ultra-violet lamps.

The reflective plate 230 is arranged adjacent to the bottom surface 213 of the light guiding plate 210 to reflect the lights emitted from the bottom surface 213 into the light guiding plate 210.

A first surface of the prism plate 240 includes a trench-shaped prism structure 241. A second surface of the prism plate 240 is planar and is arranged adjacent to the light emitting surface 211 of the light guiding plate 210. The lights emitted from the prism plate 240 irradiate the liquid crystal panel 300. In one embodiment, the prism plate 240 is also made by quartz glass, and contains the hydroxyl group in the amount less than or equal to 50 ppm.

The shadow mask 250 surrounds the light source 220 so that the lights are reflected into the light incident surface 212 of the light guiding plate 210.

The light guiding plate 210 is capable of guiding the lights and to transforms a single source to a surface source. Thus, the number of the light source 220 is reduced and the light utilization efficiency is enhanced. By adopting the above arrangement of the reflective plate 230 and the shadow mask 250, the light utilization efficiency is enhanced. In addition, with the prism plate 240 and the light guiding plate 210 operating in coordination, the uniform illumination is further enhanced.

In another embodiment, the lighting assembly may only include the light guiding plate 210 and the light source 220. The light guiding plate 210 is made by quartz glass containing the hydroxyl group in the amount larger than or equal to 100 ppm. The light source 220 is arranged toward the light incident surface 212 of the light guiding plate 210. The light emitting surface 211 of the light guiding plate 210 is arranged directly adjacent to the liquid crystal panel 300. Such arrangement is acceptable when the requirement of uniform illumination is not high.

As stated above, the lighting assembly includes the light guiding plate and the light sources. The light guiding plate is made by quartz glass with the hydroxyl group in the amount less than or equal to 100 ppm. The light source is arranged toward the light incident surface of the light guiding plate. The lights emitted by the light sources are guided by the light guiding plate so as to form the surface source. Thus, the number of the light sources is reduced so as to enhance the light utilization rate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lighting assembly for liquid crystal alignment, comprising:
a light guiding plate made by quartz glass, the light guiding plate comprises a light emitting surface, a light incident surface adjacent to the light emitting surface, and a bottom surface opposite to the light emitting surface, the bottom surface being printed with a dot pattern for reflecting and guiding lights;
a light source facing toward the light incident surface of the light guiding plate;
a reflective plate adjacent to the bottom surface of the light guiding plate;
a prism plate made by quartz glass, the prism plate comprising a first surface with a trench-shaped prism structure, and a second surface adjacent to the light emitting surface of the light guiding, plate; and
wherein the light guiding plate containing a hydroxyl group in an amount less than or equal to 100 ppm, the prism plate containing the hydroxyl group in the amount less than or equal to 50 ppm, and the light source comprises ultra-violet lamps.

2. The lighting assembly as claimed in claim 1, wherein the light guiding plate contains the hydroxyl group in the amount less than or equal to 50 ppm.

3. The lighting assembly as claimed in claim 1, wherein the lighting assembly further comprises a shadow mask surrounding the light source so that the lights are reflected into the light incident surface of the light guiding plate.

4. The lighting assembly as claimed in claim 1, wherein the light source comprises at least two ultra-violet lamps.

5. The lighting assembly as claimed in claim 1, wherein the dot pattern is made by metallic lead.

6. A lighting assembly for liquid crystal alignment, comprising:
a light guiding plate made by quartz glass, the light guiding plate comprises a light emitting surface, a light incident surface adjacent to the light emitting, surface, and a bottom surface opposite to the light emitting surface;
a light source facing toward the light incident surface of the light guiding plate; and
wherein the light guiding plate contains the hydroxyl group in an amount less than or equal to 100 ppm.

7. The lighting assembly as claimed in claim 6, wherein the lighting assembly further comprises a reflective plate adjacent to the bottom surface of the light guiding plate.

8. The lighting assembly as claimed in claim 6, wherein the lighting assembly further comprises a prism plate, the prism plate comprises a first surface with a trench-shaped prism structure, and a second surface adjacent to the light emitting surface of the light guiding plate.

9. The lighting assembly as claimed in claim 8, wherein the prism plate is made by the quartz glass, and contains the hydroxyl group in the amount less than or equal to 50 ppm.

10. The lighting assembly as claimed in claim 6, wherein the light guiding plate contains the hydroxyl group in the amount less than or equal to 50 ppm.

11. The lighting assembly as claimed in claim 6, wherein the lighting assembly further comprises a shadow mask surrounding the light source so that the lights are reflected into the light incident surface of the light guiding plate.

12. The lighting assembly as claimed in claim 6, wherein the light source are ultra-violet lamps.

13. The lighting assembly as claimed in claim 12, wherein the light sources comprises at least two ultra-violet lamps.

14. The lighting assembly as claimed in claim 6, wherein the bottom surface of the light guiding plate is printed with a dot pattern for reflecting and guiding lights.

15. The lighting assembly as claimed in claim 14, wherein the dot pattern is made by metallic lead.
